(19) United States
(12) Patent Application Publication
(10) Pub. No.: US 2014/0108966 A1
(43) Pub. Date: Apr. 17, 2014

(54) Method, sharing platform, and system for sharing image-editing action

(71) Applicant: Tencent Technology (Shenzhen) Company Limited, Shenzhen (CN)

(72) Inventor: Feiyue Huang, Shenzhen (CN)

(21) Appl. No.: 14/140,809

(22) Filed: Dec. 26, 2013

Related U.S. Application Data
(63) Continuation-in-part of application No. PCT/CN2012/078884, filed on Jul. 19, 2012.

(30) Foreign Application Priority Data
Aug. 1, 2011 (CN) 2011102184275

(51) Int. Cl. H04L 29/06; G06F 3/0484

(52) U.S. Cl. CPC H04L 65/403; G06F 3/04845
USPC 715/753

(57) ABSTRACT

The present disclosure is applicable to an information processing field. A method and system for sharing an image-editing action are provided. In the method, a sharing platform receives and stores image-editing action information from each transmitting party, a requesting party transmits an image-editing action information sharing request to the sharing platform, the sharing platform searches for the image-editing action information corresponding to the sharing request, and transmits the image-editing action information searched out to the requesting party, and the requesting party edits a selected image using the image-editing action information returned by the sharing platform. According to the disclosure, the image-editing action information can be directly invoked or shared, thus effectively reducing repetitive image-editing operations for users and improving image-editing efficiency.

### CROSS REFERENCE TO RELATED APPLICATIONS

This is a continuation-in-part application of International Patent Application No. PCT/CN2012/078884, filed on Jul. 19, 2012, which claims priority to Chinese Patent Application No. 201110218427.5 filed on Aug. 1, 2011 by the applicant Tencent Technology (Shenzhen) Company Limited and entitled “website presenting method and browser”, the disclosure of which is hereby incorporated by reference herein in its entirety.

### TECHNICAL FIELD

The present disclosure relates to information processing, and in particular to a method, sharing platform, and system for sharing an image-editing action.

### BACKGROUND

Most existing images on the Internet are shared after being edited by users using relevant editing software (e.g. Photoshop etc.). Certain professional knowledge and skills are required for the users to edit these images. Some complicated image-editing has a high threshold for users, and thus is unavailable to most of the users.

Although there are many relevant image-editing tutorials on the Internet currently and the users may perform image editing according to these image-editing tutorials, image-editing actions in these image-editing tutorials cannot be invoked or shared directly. For some complicated image-editing processes, the users have to perform complex actions according to image-editing tutorials step by step, which is not only time-consuming, but also error-prone.

### SUMMARY

Embodiments of the present disclosure provide a method, sharing platform, and system for sharing an image-editing action, to overcome the deficiency in the prior art that an image-editing action cannot be directly invoked or shared.

An embodiment of the present disclosure provides a method for sharing an image-editing action, which includes: receiving and storing, by a sharing platform, image-editing action information from each transmitting party; receiving, by the sharing platform, an image-editing action information sharing request from a requesting party; searching, by the sharing platform, for the image-editing action information corresponding to the sharing request; and transmitting, by the sharing platform, the image-editing action information searched out to the requesting party.

Another embodiment of the present disclosure provides a sharing platform, including: a first information receiving unit, configured to receive and store image-editing action information from each transmitting party, and to receive an image-editing action information sharing request from a requesting party; an information searching unit, configured to search for the image-editing action information corresponding to the image-editing action information sharing request, upon receipt of the sharing request from the requesting party; and a second information transmitting unit, configured to transmit the searched out image-editing action information corresponding to the sharing request to the requesting party.

Yet another embodiment of the present disclosure provides a system for sharing an image-editing action, comprising: a sharing platform, at least one transmitting party and at least one requesting party, wherein the transmitting party is configured to transmit image-editing action information to the sharing platform, wherein the sharing platform is configured to receive and store the image-editing action information from each or the transmitting party, to search for the image-editing action information corresponding to an image-editing action information sharing request upon receipt of the sharing request from the requesting party, and to transmit the image-editing action information searched out to the requesting party, and wherein the requesting party is configured to transmit the image-editing action information sharing request to the sharing platform, to receive the image-editing action information returned by the sharing platform corresponding to the sharing request, and to edit a selected image using the image-editing action information.

According to the embodiments of the present disclosure, a sharing platform receives and stores image-editing action information from each transmitting party, and searches for the image-editing action information corresponding to an image-editing action information sharing request upon receipt of the sharing request from the requesting party, and transmits the searched out image-editing action information to the requesting party, and the requesting party directly edits a selected image using the image-editing action information. Accordingly, an image-editing action can be invoked or shared directly, thus effectively reducing repetitive image-editing operations for users, improving image-editing efficiency and reducing the image-editing error rate.

### BRIEF DESCRIPTION OF THE DRAWINGS

FIG. 1 is a frame diagram of a system for sharing an image-editing action according to a first embodiment of the present disclosure;

FIG. 2 is a flowchart for implementing a method for sharing an image-editing action according to a second embodiment of the present disclosure;

FIG. 3 is a flowchart illustrating specific implementation of storage of an image-editing action according to the second embodiment of the present disclosure;

FIG. 4 is a diagram illustrating a structure of a transmitting party in a system for sharing an image-editing action according to a third embodiment of the present disclosure;

FIG. 5 is a diagram illustrating a structure of a first information transmitting unit according to the third embodiment of the present disclosure;

FIG. 6 is a structural diagram illustrating a structure of a sharing platform in a system for sharing an image-editing action according to a fourth embodiment of the present disclosure;

FIG. 7 is a diagram illustrating a structure of a requesting party in a system for sharing an image-editing action according to a fifth embodiment of the present disclosure; and

FIG. 8 is a diagram of an exemplary computer platform on which the method or system described in connection with FIGS. 1-7 is implemented.

### DETAILED DESCRIPTION

To make the technical solutions and advantages of the present disclosure clearer, the present disclosure is described in detail with reference to the accompanying drawings and embodiments. It should be understood that the specific embodiments described here are only used for interpreting the present disclosure, but not used for limiting it.

In an embodiment of the present disclosure, a sharing platform receives and stores image-editing action information transmitted by each transmitting party, and when receiving from a requesting party an image-editing action information sharing request, searches for image-editing action information corresponding to the sharing request and transmits to the requesting party the image-editing action information searched out; and the requesting party directly edits a selected image using the image-editing action information. Accordingly, users no longer need to edit an image step by step. Instead, image-editing actions can be invoked or shared directly, thus effectively reducing repetitive operations of image-editing for the users, improving image editing efficiency and reducing the probability of image-editing errors.

The technical solutions of the present disclosure will be illustrated below through the specific embodiments.

### Embodiment 1

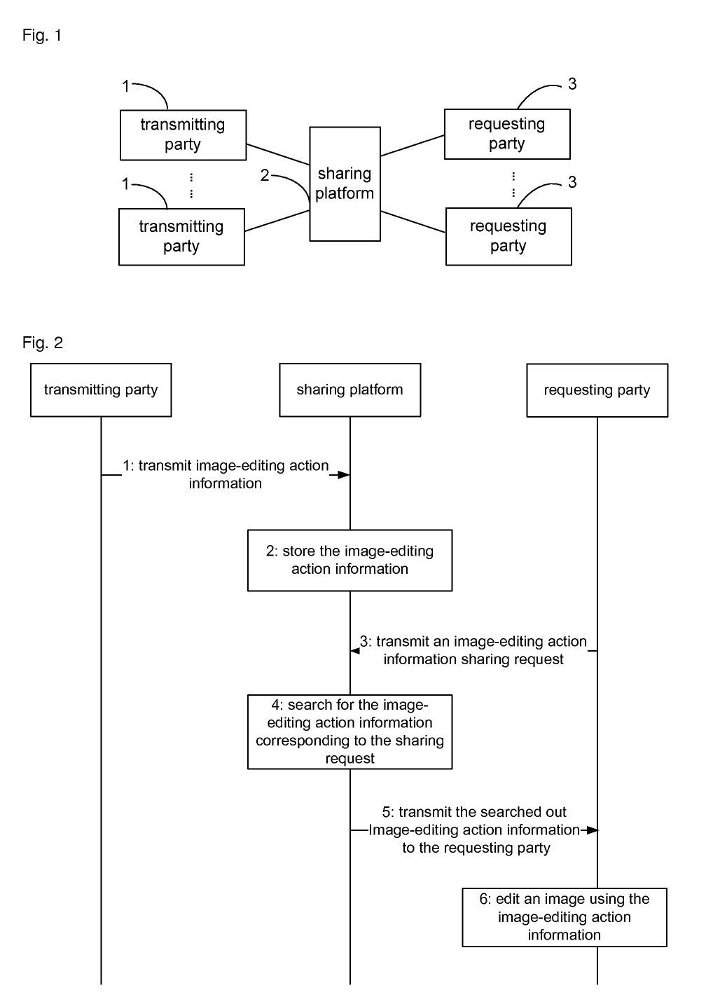

FIG. 1 shows a framework of a system for sharing an image-editing action according to an embodiment of the disclosure. For convenience of explanation, only parts related to the embodiment of the present disclosure are illustrated.

In the embodiment of the present disclosure, the system for sharing an image-editing action includes a sharing platform 2, one or more transmitting parties 1 arranged in a distributed manner and one or more requesting parties 3 arranged in a distributed manner. Each of the transmitting parties 1 and each of requesting parties 3 communicate with the sharing platform 2.

The transmitting party 1 transmits edited image-editing action information to the sharing platform 2.

The sharing platform 2 is connected to the transmitting parties 1 and the requesting parties 3 in a wired or wireless manner. The sharing platform 2 receives and stores the image-editing action information from each of transmitting parties 1. When the sharing platform 2 receives an image-editing action information sharing request from a requesting party 3, the sharing platform 2 searches for image-editing action information corresponding to the sharing request, and transmits to the requesting party 3 the image-editing action information retrieved.

The sharing platform 2 may also provide a human-computer interaction interface for a user, such that the user may view the stored image-editing action information etc. through the human-computer interaction interface.

The requesting party 3 is located in a user terminal. The requesting party 3 sends the image-editing action information sharing request to the sharing platform 2, receives the image-editing action information returned by the sharing platform 2 corresponding to the sharing request, and edits a selected image using the image-editing action information.

### Embodiment 2

FIG. 2 shows a flowchart for implementing a method for sharing an image-editing action based on the framework illustrated by FIG. 1 according to the second embodiment of the present disclosure. The process of the method is described in detail as follows.

Step 1: the transmitting party transmits image-editing action information to the sharing platform.

In the present embodiment, the image-editing action information includes, but is not limited to, an original image, a file in which at least one editing action is stored, and an image resulted by editing the original image through the editing action. The editing action includes at least one editing instruction and at least one editing parameter each editing instruction corresponding to at least one editing parameter.

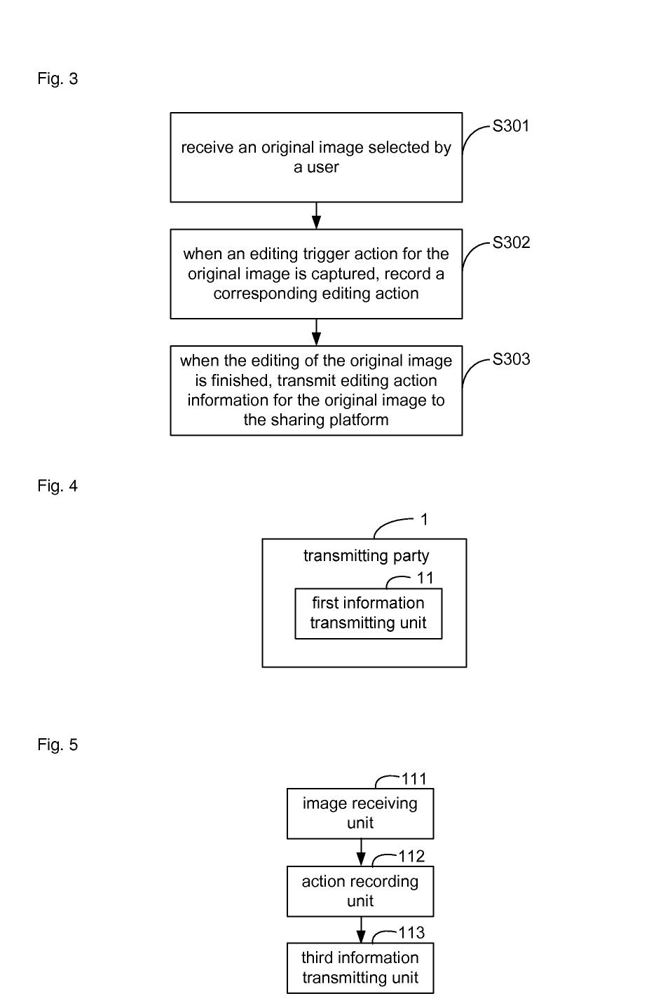

Specific steps for transmitting image-editing action information from each of transmitting parties to the sharing platform in the present embodiment are illustrated in FIG. 3.

In Step S301, an original image selected by a user is received.

In the present embodiment, the original image is an image to be edited, and the user may load the selected original image from an image-editing window of a client by means of cutting or copying. The user may also load the selected original image from a storage path of the selected image.

In Step S302, when an editing trigger action for the original image is captured, a corresponding editing action is recorded.

In the present embodiment, the editing trigger action for the selected original image (e.g. a double mouse-click action, etc.) may be captured by using a window message response function. When the editing trigger action for the original image is captured, the corresponding editing action is recorded, and an enumerated value is defined for the editing action so that the user can learn the specific meaning of the editing action. The editing action includes at least one editing instruction and at least one editing parameter.

For example, when an editing trigger action (e.g. a double mouse-click) for an original image is captured, a corresponding editing action is indicated by a variable name Act (1). At the same time, an enumerated value of “image sharpening” is defined for the editing action (i.e. double mouse-clicking indicates that an operation of sharpening the image has to be performed), indicating that the editing action is performed to improve the definition of the original image and record such editing instructions as image contour compensation, image edge enhancement and gray level jump, etc. included in the editing action. Each editing instruction corresponds to at least one editing parameter, e.g. the gray level jump editing instruction corresponds to a gray level setting parameter.

In Step S303, when the editing of the original image is finished, editing action information for the original image is transmitted to the sharing platform.

In the present embodiment, after the original image is edited through a series of editing actions (including at least one editing action), the series of editing actions are saved in a file in editing order. At the same time, the file containing the original image and storing the series of editing actions, and the image-editing action information of the image resulted by editing the original image through the series of editing actions are transmitted to the sharing platform;

Step 2: the sharing platform receives and stores image-editing action information from each of the transmitting parties.

In the present embodiment, the sharing platform filters out repeated image-editing action information when receiving the image-editing action information from each transmitting parties, and establishes a corresponding storage relation between an image-editing keyword and image-editing action information when storing the filtered image-editing action information.

Step 3: the requesting party transmits an image-editing action information sharing request to the sharing platform.

In the present embodiment, the requesting party transmits the image-editing action information sharing request to the sharing platform by means of an image-editing keyword;

Step 4: the sharing platform searches for the image-editing action information corresponding to the sharing request.

In the present embodiment, when the sharing platform receives the sharing request from the requesting party, the sharing platform searches for the image-editing action information corresponding to the sharing request, according to the established corresponding storage relation between the image-editing keyword and the image-editing action information.

Step 5: the sharing platform transmits the searched out image-editing action information corresponding to the sharing request to the requesting party.

Step 6: the requesting party edits a selected image using the image-editing action information returned by the sharing platform.

In the present embodiment, the image-editing action information obtained by the requesting party may be a file in which image-editing actions are stored. The image-editing actions in the file are read in storage order. The selected image is directly edited using the image-editing actions.

In the present embodiment, the image-editing action information of the sharing platform is invoked directly to implement automatic editing of the image, so that the user no longer needs to edit the image through performing tedious operations step by step, thus effectively reducing repetitive image-editing operations of users and improving the image-editing efficiency as well as the user satisfaction.

### Embodiment 3

FIG. 4 shows a structure of a transmitting party in a system for sharing an image-editing action according to the third embodiment of the present disclosure. For convenience of explanation, only parts related to the embodiment of the present disclosure are illustrated.

The transmitting party 1 in the system for sharing an image-editing action includes a first information transmitting unit 11.

The first information transmitting unit 11 is configured to transmit image-editing action information to a sharing platform. As shown in FIG. 5, the first information transmitting unit 11 specifically includes an image receiving unit 111, an action recording unit 112 and a third information transmitting unit 113. Specific functions of the respective units are provided as follows.

The image receiving unit 111 is configured to receive an original image selected by a user.

The action recording unit 112 is configured, when an editing trigger action for the original image is captured, to record a corresponding editing action.

The third information transmitting unit 113 is configured to transmit the editing action information for the original image to the sharing platform when the editing of the original image is finished.

In the present embodiment, the specific implementations of each unit have been described above and will be omitted here.

### Embodiment 4

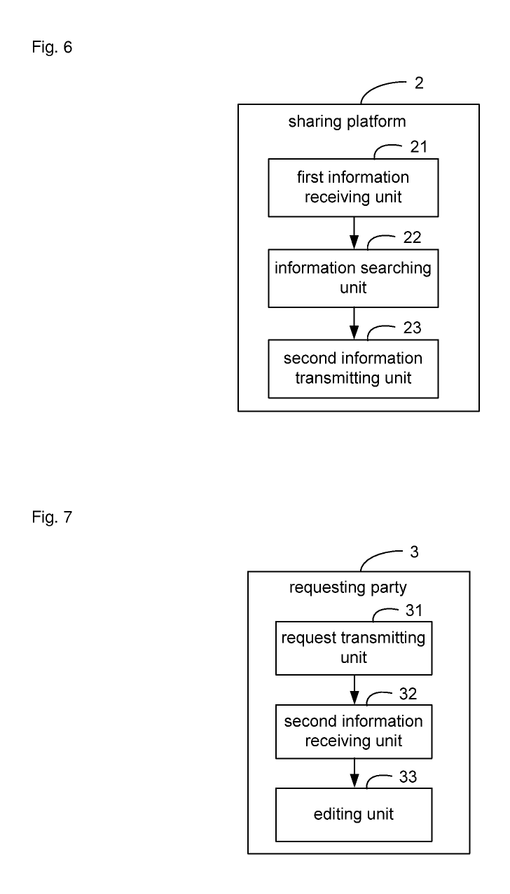

FIG. 6 shows a structure of a sharing platform in a system for sharing an image-editing action according to the fourth embodiment of the present disclosure. For convenience of explanation, only parts related to the embodiment of the present disclosure are illustrated.

The sharing platform 2 in the system for sharing an image-editing action includes: a first information receiving unit 21, an information searching unit 22 and a second information transmitting unit 23. Specific functions of the respective units are provided as follows.

The first information receiving unit 21 is configured to receive and store image-editing action information from each transmitting party.

The information searching unit 22 is configured to search for image-editing action information corresponding to an image-editing action information sharing request upon receipt of the sharing request from a requesting party.

The second information transmitting unit 23 is configured to transmit the searched out image-editing action information corresponding to the sharing request to the requesting party.

In the present embodiment, the specific implementations of each unit have been described above and will be omitted here.

### Embodiment 5

FIG. 7 shows a structure of a requesting party in a system for sharing an image-editing action according to the fifth embodiment of the present disclosure. For convenience of explanation, only parts related to the embodiment of the present disclosure are illustrated.

The requesting party 3 in the system for sharing an image-editing action includes: a request transmitting unit 31, a second information receiving unit 32 and an editing unit 33. Specific functions of the respective units are provided as follows.

The request transmitting unit 31 is configured to transmit an image-editing action information sharing request to a sharing platform.

The second information receiving unit 32 is configured to receive the image-editing action information returned by the sharing platform corresponding to the sharing request.

The editing unit 33 is configured to edit a selected image using the image-editing action information returned by the sharing platform.

In the present embodiment, the specific implementations of each unit have been described above and will be omitted here.

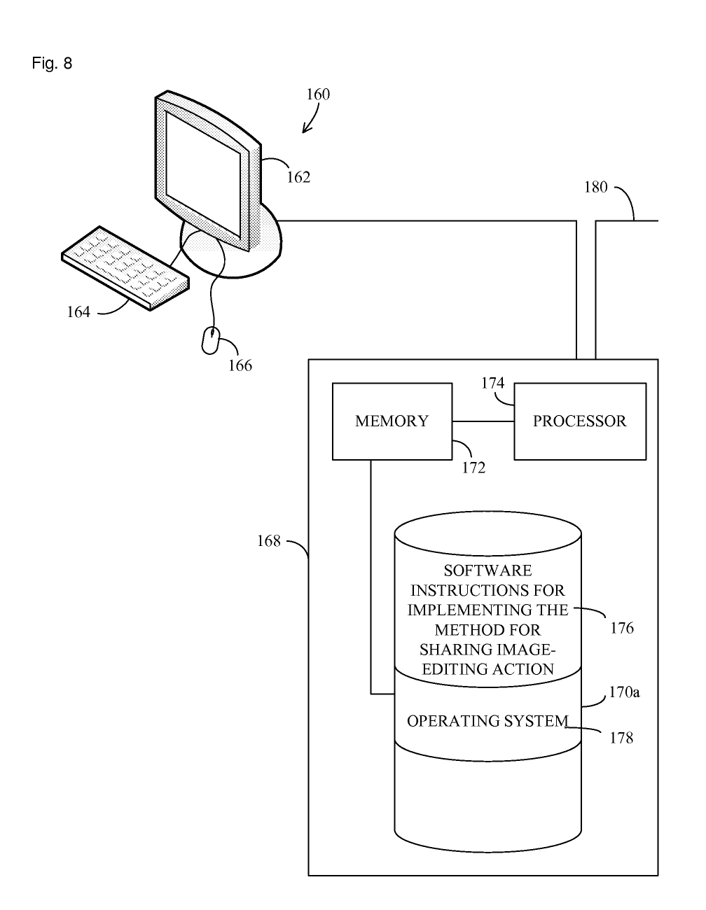

FIG. 8 is a diagram of an exemplary computer platform 160 on which the method or system described in connection with FIGS. 1-7 is implemented. For example, each of the sharing platform, the transmitting party and the requesting party may be implemented by a respective computer platform 160. As shown in FIG. 8, the computer platform includes a display 162, a keyboard 164, a pointing device 166 such as a mouse, and a digital computer 168. The digital computer 168 includes memory 172, a processor 174, a mass storage device 170a and other customary components such as a memory bus and peripheral bus (not shown). The platform 160 may further include a network connection 180.

Mass storage device 170a can store the instructions 176 for implementing the steps performed at one of the sharing platform, the transmitting party or the requesting party over an operating system 178. The instructions 176 may be transferred to memory 172 and processor 174 in the course of operation. The instructions 176 can be stored on a variety of mass storage devices, including semiconductor memory devices, such as EPROM, EEPROM and flash memory devices; magnetic devices, such as internal hard disks and removable disks; magneto-optical disks; and CD-ROM disks.

Any of the foregoing may be supplemented by, or implemented in, specifically-designed ASICs (application specific integrated circuits).

It should be noted that electronic devices suitable for implementing the method or the system according to the disclosure is not limited to the computer platform 160 as shown in FIG. 8. The electronic devices may be of any type, such as computers (e.g., desktop, notebook, netbook, tablet) and mobile devices (e.g., mobile telephones, tablet computers, game consoles, personal digital assistants). In some implementations, the electronic devices are client devices that are connected to servers via a computer or communications network (e.g., a cellular network or the Internet). These client devices communicate with the servers through wired or wireless connections.

Persons of ordinary skill in the art may understand that all or a part of the processes of the method in the embodiments may be implemented by a computer program instructing relevant hardware. The program may be stored in a computer readable storage medium. The program, when executed, includes the processes of the method in the embodiments. The storage medium may be magnetic disk, optical disk, Read-Only Memory (ROM), Random Access Memory (RAM), or the like.

In the embodiments of the present disclosure, in the system for sharing an image-editing action, the terms “first”, “second” and “third” in the names of the units are used for distinguishing different units by name, and do not have progressive meanings.

According to the embodiments of the present disclosure, a sharing platform receives and stores image-editing action information from each transmitting party, and searches for the image-editing action information corresponding to an image-editing action information sharing request upon receipt of the sharing request from the requesting party, and transmits the searched out image-editing action information to the requesting party, and the requesting party directly edits a selected image using the image-editing action information. Accordingly, an image-editing action can be invoked or shared directly, thus effectively reducing repetitive image-editing operations for users, improving image-editing efficiency and reducing the image-editing error rate. Through the sharing of the edited image-editing action information, users without professional knowledge and skills can edit an image through simple operations rather than tedious step-by-step operations, thus greatly improving user satisfaction and image-editing efficiency. Therefore, the disclosure provides a practical solution.

The foregoing descriptions are merely preferred embodiments of the present disclosure, but not intended to limit the present disclosure. Any modifications, equivalent replacements and improvements and the like made within the spirit and principle of the present disclosure shall be included in the scope of protection of the present disclosure.

1. A method for sharing an image-editing action, comprising:
receiving and storing, by a sharing platform, image-editing action information from each transmitting party;
receiving, by the sharing platform, an image-editing action information sharing request from a requesting party;
searching, by the sharing platform, for the image-editing action information corresponding to the sharing request; and
transmitting, by the sharing platform, the image-editing action information searched out to the requesting party.

2. The method according to claim 1, wherein the image-editing action information comprises an original image, a file in which at least one editing action is stored and an edited image.

3. The method according to claim 1, wherein before the sharing platform receives and stores the image-editing action information from each transmitting party, the method further comprises:
receiving, by the transmitting party, a selected original image;
recording, by the transmitting party when an editing trigger action for the original image is captured, a corresponding editing action; and
transmitting, by the transmitting party, editing action information for the original image to the sharing platform when the editing of the original image is finished.

4. The method according to claim 1, wherein after transmitting the image-editing action information searched out to the requesting party, the method further comprises:
editing, by the requesting party, a selected image using the image-editing action information returned by the sharing platform.

5. A sharing platform, comprising:
a first information receiving unit, configured to receive and store image-editing action information from each transmitting party, and to receive an image-editing action information sharing request from a requesting party;
an information searching unit, configured to search for the image-editing action information corresponding to the image-editing action information sharing request, upon receipt of the sharing request from the requesting party; and
a second information transmitting unit, configured to transmit the searched out image-editing action information corresponding to the sharing request to the requesting party.

6. The method according to claim 5, wherein the image-editing action information comprises an original image, a file in which at least one editing action is stored and an edited image.

7. A system for sharing an image-editing action, comprising: a sharing platform, at least one transmitting party and at least one requesting party,
wherein the transmitting party is configured to transmit image-editing action information to the sharing platform,
wherein the sharing platform is configured to receive and store the image-editing action information from each or the transmitting party, to search for the image-editing action information corresponding to an image-editing action information sharing request upon receipt of the sharing request from the requesting party, and to transmit the image-editing action information searched out to the requesting party, and
wherein the requesting party is configured to transmit the image-editing action information sharing request to the sharing platform, to receive the image-editing action information returned by the sharing platform corresponding to the sharing request, and to edit a selected image using the image-editing action information.

8. The system according to claim 7, wherein the transmitting party comprises:
a first information transmitting unit, configured to transmit the image-editing action information to the sharing platform.

9. The system according to claim 8, wherein the first information transmitting unit comprises an image receiving unit, an action recording unit and a third image transmitting unit,
wherein the image receiving unit is configured to receive the selected original image,
wherein the action recording unit is configured, when an editing trigger action for the original image is captured, to record a corresponding editing action, and
wherein the third information transmitting unit is configured to transmit the editing action information for the original image to the sharing platform when the editing of the original image is finished.

10. The system according to claim 7, wherein the sharing platform comprises:
a first information receiving unit, configured to receive and store the image-editing action information from each or the transmitting party;
an information searching unit, configured to search for the image-editing action information corresponding to the image-editing action information sharing request, upon receipt of the sharing request from the requesting party; and
a second information transmitting unit, configured to transmit the searched out image-editing action information corresponding to the sharing request to the requesting party.

11. The system according to claim 7, wherein the requesting party comprises:
a request transmitting unit, configured to transmit the image-editing action information sharing request to the sharing platform;
a second information receiving unit, configured to receive the image-editing action information returned by the sharing platform corresponding to the sharing request; and
an editing unit, configured to edit the selected image using the image-editing action information returned by the sharing platform.

12. The system according to claim 7, wherein the image-editing action information comprises an original image, a file in which at least one editing action is stored and an edited image.

13. A non-transitory computer-readable storage medium including a first set of instructions that, when executed, cause at least one processor to perform steps as recited in claim 1.

14. The non-transitory computer-readable storage medium according to claim 13, further including a second set of instructions that, when executed, cause at least one processor to:
receive a selected original image;
when an editing trigger action for an original image is captured, record a corresponding editing action; and
transmit editing action information for the original image to a sharing platform when the editing of the original image is finished.

15. The non-transitory computer-readable storage medium according to claim 13, further including a third set of instructions that, when executed, cause at least one processor to:
transmit the image-editing action information sharing request to the sharing platform, receive the image-editing action information returned by the sharing platform corresponding to the sharing request, and
edit a selected image using the image-editing action information.
